(19) United States
(12) Patent Application Publication
(10) Pub. No.: US 2010/0055425 A1
(43) Pub. Date: Mar. 4, 2010

(54) COMPOSITE PART CONSISTING OF A FILM AND A SUBSTRATE BASED ON AN AMORPHOUS POLYAMIDE

(75) Inventors: Kirsten Luetzeler, Muenster (DE); Klaus Huelsmann, Haltern am See (DE); Martin Wielpuetz, Senden (DE); Roland Wursche, Duelmen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GMBH, ESSEN (DE)

(21) Appl. No.: 12/373,547

(22) PCT Filed: Aug. 24, 2007
(86) PCT No.: PCT/EP2007/058796

§ 371 Date: Jan. 13, 2009

(30) Foreign Application Priority Data
Sep. 1, 2006 (DE) 102006041138.2

(51) Int. Cl. B32B 7/02; B32B 37/00; B29C 44/06

(52) U.S. Cl. 428/212; 156/60; 264/41

(57) ABSTRACT

A film which comprises a layer composed of a moulding composition composed of a semicrystalline polyamide whose enthalpy of fusion is at least 8 J/g is used for production of a composite part with a substrate composed of a moulding composition composed of a substantially amorphous polyamide whose enthalpy of fusion is less than 8 J/g.

The invention relates to composite parts composed of a film and of a substrate based on a substantially amorphous polyamide.

Injection-moulded or extruded mouldings composed of amorphous polyamide are widely used, because amorphous polyamide has transparency, high impact resistance and other good optical and mechanical properties. However, amorphous polyamides lack chemicals resistance and have pronounced susceptibility to stress cracking, and mouldings composed thereof cannot therefore be used where there is some risk of exposure to solvents or to chemicals.

An object underlying the invention is to eliminate the abovementioned disadvantages and to provide articles based on a moulding composition composed of a substantially amorphous polyamide which are not susceptible to stress cracking, and are sufficiently scratch-resistant and abrasion-resistant, while very substantially retaining transparency.

This object has been achieved via a composite part composed of
I. a film which comprises a layer I. a) composed of a moulding composition composed of a semicrystalline polyamide, and
II. a substrate composed of a moulding composition composed of a substantially amorphous polyamide.

The invention also provides the use of the film according to I. for production of a composite part which comprises a substrate according to II.

No restriction applies to the semicrystalline polyamide of the layer according to I. a). The main materials that can be used here are aliphatic homo- and copolycondensates, such as PA46, PA66, PA88, PA610, PA612, PA810, PA1010, PA1012, PA1212, PA6, PA7, PA8, PA9, PA10, PA 11 and PA 12. (The terminology for the polyamides corresponds to an international standard where the first numeral(s) give(s) the carbon number of the starting diamine and the second numeral(s) give(s) the carbon number of the dicarboxylic acid. If only one numeral is given, this means that the starting material was an 60 ,ω-aminocarboxylic acid or the lactam derived therefrom; for further information reference may be made to H. Domininghaus, Die Kunststoffe und ihre Eigenschaften [Plastics and their properties], pages 272 et seq., VDI-Verlag, 1976.)

If copolyamides are used these may contain, by way of example, adipic acid, sebacic acid, suberic acid, isophthalic acid, terephthalic acid, naphthalene-2,6-dicarboxylic acid, etc. as coacid and, respectively, bis(4-aminocyclohexyl)methane, bis(3-methyl-4-aminocyclohexyl)methane, trimethylhexamethylenediamine, hexamethylenediamine or the like as codiamine. There may also be lactams, such as caprolactam or laurolactam, or aminocarboxylic acids, such as ω-aminoundecanoic acid, incorporated as cocomponent.

The preparation of these polyamides is known (e.g. D. B. Jacobs, J. Zimmermann, Polymerization Processes, pp. 424-467, Interscience Publishers, New York, 1977; DE-B 21 52 194).

Other suitable polyamides are mixed aliphatic/aromatic polycondensates as described by way of example in U.S. Pat. Nos. 4,163,101, 4,603,166, 4,831,108, 5,112,685, 5,436,294 and 5,447,980, and also in EP-A-0 309 095. These are generally polycondensates whose monomers have been selected from aromatic dicarboxylic acids, such as terephthalic acid and isophthalic acid, from aliphatic dicarboxylic acids, such as adipic acid, from aliphatic diamines, such as hexamethylenediamine, nonamethylenediamine, dodecamethylenediamine and 2-methyl-1,5-pentanediamine, or else from lactams or ω-aminocarboxylic acids, such as caprolactam, laurolactam and ω-aminoundecanoic acid. The content of aromatic monomer units in the polycondensate is generally at least 0.1%, at least 5%, at least 10%, at least 15%, at least 20%, at least 25%, at least 30%, at least 35%, at least 40%, or at least 45% or about 50%, based on the entirety of the monomer units. These polycondensates are often termed “polyphthalamides” or “PPA”. Other suitable polyamides are poly(etheresteramides) or poly(etheramides); products of this type are described by way of example in DE-A 25 23 991, DE-A 27 12 987 and DE-A 30 06 961.

The enthalpy of fusion of the semicrystalline polyamide is at least 8 J/g, preferably at least 10 J/g, more preferably at least 12 J/g and even more preferably at least 16 J/g, measured by the DSC method to ISO 11357 during the 2nd heating procedure and integration of the melting peak.

The polyamide moulding composition can either comprise one of these polyamides or two or more in the form of a mixture. As long as other thermoplastics do not impair bonding capability, up to 40% by weight of these can moreover be present, in particular impact-modifying rubbers, such as ethylene-propylene copolymers or ethylene-propylene-diene copolymers, polypentenylene, polyoctenylene, random or block copolymers composed of alkenyl aromatic compounds with aliphatic olefins or dienes (EP-A-0 261 748), or core-shell rubbers with a tough, resilient core composed of (meth)acrylate rubber, of butadiene rubber, or of styrene-butadiene rubber with glass transition temperatures T_{g}<−10° C., where the core may have been crosslinked and the shell can be composed of styrene and/or of methyl methacrylate and/or of other unsaturated monomers (DE-A 21 44 528, DE-A 37 28 685).

The polyamide moulding composition can receive additions of the auxiliaries and additives conventional for polyamides, examples being flame retardants, stabilizers, UV absorbers, plasticizers, processing aids, fillers, in particular for improving electrical conductivity, nanofillers, pigments, dyes, nucleating agents, or the like. The amount added of the agents mentioned is to be such as not to give any serious impairment of the desired properties. For most applications, it is desirable that the polyamide moulding composition has sufficient transparency at the layer thickness selected.

In one preferred embodiment, the monomer units of the polyamide which derive from diamine, dicarboxylic acid, or lactam (or aminocarboxylic acid) have an average of at least 8 carbon atoms and particularly preferably at least 9 carbon atoms.

For the purposes of the invention, particularly suitable polyamides are:
the polyamide composed of 1,12-dodecanedioic acid and 4,4′-diaminodicyclohexylmethane (PA PACM12), in particular starting from a 4,4′-diaminodicyclohexylmethane whose trans, trans-isomer content is from 35 to 65%;
PA612, PA1010, PA1012, PA11, PA12, PA1212, and mixtures thereof;
copolyamides that can be prepared from the following monomer combination:
   a) from 65 to 99 mol %, preferably from 75 to 98 mol %, particularly preferably from 80 to 97 mol % and with particular preference from 85 to 96 mol %, of an in essence equimolar mixture composed of an aliphatic unbranched diamine and of an aliphatic unbranched dicarboxylic acid, where the mixture, if appropriate, takes the form of salt and moreover each diamine and dicarboxylic acid is counted individually in the calculation of the constitution, with the restriction that the mixture composed of diamine and dicarboxylic acid contains an average of from 8 to 12 carbon atoms and preferably from 9 to 11 carbon atoms per monomer;
   b) from 1 to 35 mol %, preferably from 2 to 25 mol %, particularly preferably from 3 to 20 mol % and with particular preference from 4 to 15 mol % of an in essence equimolar mixture composed of a cycloaliphatic diamine and of a dicarboxylic acid.

The substrate is composed of a moulding composition which comprises, as main constituent, a substantially amorphous polyamide. The enthalpy of fusion of the substantially amorphous polyamide is less than 8 J/g, preferably less than 6 J/g, particularly preferably less than 4 J/g and with particular preference less than 3 J/g, measured by the DSC method to ISO 11357 in the 2nd heating procedure and integration of any melting peak present.

Examples of substantially amorphous polyamides that can be used according to the invention are:
the polyamide composed of terephthalic acid and/or isophthalic acid and of the isomer mixture composed of 2,2,4- and 2,4,4-trimethylhexamethylenediamine,
the polyamide composed of isophthalic acid and 1,6-hexamethylenediamine,
the copolyamide composed of a mixture composed of terephthalic acid/isophthalic acid and 1,6-hexamethylenediamine, if appropriate in a mixture with 4,4′-diaminodicyclohexylmethane,
the copolyamide composed of terephthalic acid and/or isophthalic acid, 3,3′-dimethyl-4,4′-diaminodicyclohexylmethane and laurolactam or caprolactam,
the (co)polyamide composed of 1,12-dodecanedioic acid or sebacic acid, 3,3′-dimethyl-4,4′-diaminodicyclohexylmethane and, if appropriate, laurolactam or caprolactam,
the copolyamide composed of isophthalic acid, 4,4′-diaminodicyclohexylmethane and laurolactam or caprolactam,
the polyamide composed of 1,12-dodecanedioic acid and 4,4′-diaminodicyclohexylmethane (given a low proportion of trans,trans-isomer),
the copolyamide composed of terephthalic acid and/or isophthalic acid and of an alkyl-substituted bis(4-aminocyclohexyl)methane homologue, if appropriate in a mixture with hexamethylenediamine,
the copolyamide composed of bis(4-amino-3-methyl-5-ethylcyclohexyl)methane, if appropriate together with a further diamine, and isophthalic acid, if appropriate together with a further dicarboxylic acid,
the copolyamide composed of a mixture of m-xylylenediamine and a further diamine, e.g. hexamethylenediamine, and isophthalic acid, if appropriate together with a further dicarboxylic acid, e.g. terephthalic acid and/or 2,6-naphthalenedicarboxylic acid,
the copolyamide composed of a mixture of bis(4-aminocyclohexyl)methane and bis(4-amino-3-methylcyclohexyl)methane and aliphatic dicarboxylic acids having from 8 to 14 carbon atoms, and
polyamides or copolyamides composed of a mixture which comprises 1,14-tetradecanedioic acid and an aromatic, arylaliphatic or cycloaliphatic diamine.

These examples can be varied very substantially via addition of further components (e.g. caprolactam, laurolactam or diamine/dicarboxylic acid combinations) or via partial or complete replacement of starting components by other components.

The polyamides mentioned, and further suitable substantially amorphous polyamides, and suitable preparation methods, are described, inter alia, in the following patent applications: WO 02090421, EP-A-0 603 813, DE-A 37 17 928, DE-A 100 09 756, DE-A 101 22 188, DE-A 196 42 885, DE-A 197 25 617, DE-A 198 21 719, DE-C 198 41 234, EP-A-1 130 059, EP-A 1 369 447, EP-A 1 595 907, CH-B-480 381, CH-B-679 861, DE-A-22 25 938, DE-A-26 42 244, DE-A-27 43 515, DE-A-29 36 759, DE-A-27 32 928, DE-A-43 10 970, EP-A-0 053 876, EP-A-0 271 308, EP-A-0 313 436, EP-A-0 725 100 and EP-A-0 725 101.

The moulding composition of the substrate can comprise the auxiliaries and additives conventionally used for transparent polyamides, examples being flame retardants, stabilizers, plasticizers, glass fibres, fillers, antistatic agents, dyes, pigments, mould-release agents, flow agents, and other polymers, where these preferably do not impair transparency, or impact modifiers. The amount of all of the auxiliaries and additives is at most 50% by weight in total, preferably at most 40% by weight, particularly preferably at most 30% by weight and with particular preference at most 20% by weight.

In many cases, the film layer composed of the moulding composition composed of the semicrystalline polyamide adheres directly to the substrate. Suitable polyamide combinations are known to the person skilled in the art or can be determined via simple experimentation. In cases where it is impossible to achieve adequate adhesion, a multilayer film can be used which comprises an adhesion-promoter layer on the substrate side. The nature of the adhesion promoter is non-critical; however, it should preferably have adequate transparency at the layer thickness selected.

In one embodiment, the adhesion promoter comprises a blend composed of a polyamide which is identical with, or similar to, the semicrystalline polyamide of the film layer, and of a polyamide which is identical with, or similar to, the amorphous polyamide of the substrate. “Similar” means that the relevant polyamides can be mixed in the melt to give blends having stable phases or, respectively, layers composed of the two polyamides have adequate adhesion to one another after the coextrusion process or after reverse coating by an injection-moulding method, and this means that the polyamides are compatible with one another. Compatible polyamide combinations are known to the person skilled in the art or can be determined via simple experimentation. The blend is usually prepared by mixing in the melt, preferably under conditions where block copolymers are produced via end-group reactions or transamidation. Conditions of this type, for example relatively high melt temperature and/or addition of a catalyst, are known to the person skilled in the art. Suitable mixing ratios in per cent by weight are 20-80:80-20, preferably 30-70:70-30 and particularly preferably 40-60:60-40.

In another embodiment, the adhesion promoter comprises from 2 to 100% by weight, preferably from 5 to 90% by weight, particularly preferably from 10 to 80% by weight, with particular preference from 15 to 60% by weight, and very particularly preferably from 20 to 40% by weight, of a copolymer which comprises the following monomer units:
from 70 to 99.9% by weight of monomer units which derive from vinyl compounds selected from acrylic acid derivatives, methacrylic acid derivatives, α-olefins and vinyl aromatics, and
from 0.1 to 30% by weight of monomer units which contain a functional group selected from a carboxylic anhydride group, an epoxide group and an oxazoline group.

The copolymer preferably contains the following monomer units:
1. from about 70 to about 99.9% by weight, preferably from 80 to 99.4% by weight, and particularly preferably from 85 to 99% by weight, of monomer units selected from units of the following formulae:

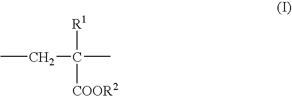

where R¹═H or CH₃ and R²═H, methyl, ethyl, propyl or butyl;

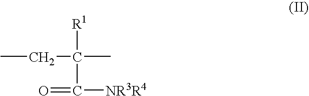

where R¹ is as above and R³ and R⁴, independently of one another, are H, methyl or ethyl;

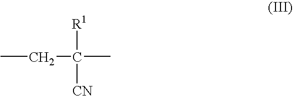

where R¹ is as above;

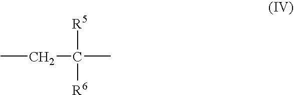

where R⁵═H or CH₃ and R⁶═H or C₆H₅;

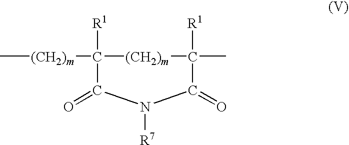

where R¹ is as above and R⁷═H, methyl, ethyl, propyl, butyl or phenyl and m=0 or 1;
2. from about 0.1 to about 30% by weight, preferably from 0.6 to 20% by weight, and particularly preferably from 1 to 15% by weight, of monomer units selected from units of the following formulae:

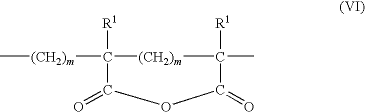

where R¹ and m are as above;

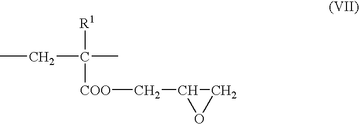

where R¹ is as above;

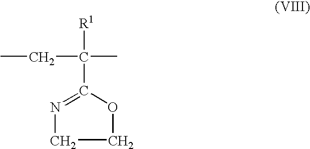

where R¹ is as above.

The limitation of chain length in the case of substituents R¹ to R⁵ and R⁷ is based on the fact that longer alkyl radicals lead to a lowered glass transition temperature and therefore to reduced heat resistance. This may be acceptable in a few cases.

The units of the formula (I) derive by way of example from acrylic acid, methacrylic acid, methyl acrylate, ethyl acrylate, n-butyl acrylate, methyl methacrylate, n-propyl methacrylate, or isobutyl methacrylate.

The units of the formula (II) derive by way of example from acrylamide, methacrylamide, N-methylacrylamide, N-methylmethacrylamide, or N,N-dimethylacrylamide.

The units of the formula (III) derive from acrylonitrile or methacrylonitrile.

The units of the formula (IV) derive from ethene, propene, styrene or α-methylstyrene; these can be replaced entirely or to some extent by other polymerizable aromatics, such as p-methylstyrene or indene, which have the same effect.

If m=0, the units of the formula (V) derive from unsubstituted or substituted maleimides, such as maleimide, N-methylmaleimide, N-ethylmaleimide, N-phenylmaleimide, or N-methylaconitimide. If m=1, they derive via reaction with ammonia or with a primary amine of two adjacent units of the formula (I) in a polymer, forming an imide.

If m=0, the units of the formula (VI) derive from unsubstituted or substituted maleic anhydrides, such as maleic anhydride or aconitic anhydride. These latter compounds can be replaced entirely or to some extent by other unsaturated acid anhydrides, e.g. itaconic anhydride, which have the same effect. If m=1, they derive via elimination of water from two adjacent units of the formula (I) in a polymer (R²═H), with ring closure.

The units of the formula (VII) derive from glycidyl acrylate or glycidyl methacrylate, and the units of the formula (VIII) derive from vinyloxazoline or isopropenyloxazoline.

Various embodiments of the copolymer are preferred, and contain the following units:
A. from 14 to 96% by weight, preferably from 20 to 85% by weight, and particularly preferably from 25 to 75% by weight, of units of the formula (I) , where R² is not H;
   from 0 to 75% by weight, preferably from 1 to 60% by weight, and particularly preferably from 5 to 40% by weight, of units of the formula (V), where m=1;
   from 0 to 15% by weight, preferably from 0 to 10% by weight, and particularly preferably from 0.1 to 7% by weight, of units of the formula (I), where R²═H;
   from 0.1 to 30% by weight, preferably from 1 to 20% by weight, and particularly preferably from 2 to 15% by weight, of units of the formula (VI), where m=1.
   If units of the formula (V) are present, these copolymers are termed polyacrylimides or polymethacrylimides or sometimes also polyglutarimides. These are products which come from polyalkyl acrylates and, respectively, polyalkyl methacrylates, in which two adjacent carboxylate groups have been reacted to give a cyclic imide. The imide is preferably formed with ammonia or with primary amines, e.g. methylamine, in the presence of water, and the units of the formula (VI) and, where appropriate, units of the formula (I), where R²═H, are produced concomitantly via hydrolysis. The products are known, as also is their preparation (Hans R. Kricheldorf, Handbook of Polymer Synthesis, Part A, Verlag Marcel Dekker Inc. New York-Basel-Hong Kong, pp. 223 et seq., H. G. Elias, Makromolekule [Macromolecules], Hüthig und Wepf Verlag Basel-Heidelberg-New York; U.S. Pat. No. 2,146,209 A; U.S. Pat. No. 4,246,374). If water only is used for the reaction, the product is units of the formula (VI) and also, if appropriate, acidic units (I) via hydrolysis, without formation of imide units (V).
B. from 10 to 60% by weight, preferably from 15 to 50% by weight and particularly preferably from 20 to 40% by weight of units of the formula (IV);
   from 39.9 to 80% by weight, preferably from 44.9 to 75% by weight and particularly preferably from 49.9 to 70% by weight of units of the formula (III);
   from 0.1 to 30% by weight, preferably from 0.6 to 20% by weight and particularly preferably from 1 to 15% by weight of units of the formula (VI), where m=0.
   Copolymers of this type are obtainable in a known manner via free-radical-initiated copolymerization of, for example, aliphatically unsaturated aromatics, unsaturated carboxylic anhydrides, and acrylonitrile or methacrylonitrile.
C. from 39.9 to 99.9% by weight, preferably from 49.9 to 99.4% by weight and particularly preferably from 59.9 to 99% by weight, of units of the formula (I);
   from 0 to 60% by weight, preferably from 0.1 to 50% by weight and particularly preferably from 2 to 40% by weight of units of the formula (IV);
   from 0.1 to 30% by weight, preferably from 0.6 to 20% by weight and particularly preferably from 1 to 15% by weight of units of the formula (VI), where m=0.
   Copolymers of this type are obtainable in a known manner via free-radical-initiated copolymerization of acrylic acid, methacrylic acid and/or esters thereof and, if appropriate, aliphatically unsaturated aromatics or olefins and unsaturated carboxylic anhydrides.
D. from 25 to 99.8% by weight, preferably from 40 to 98.4% by weight and particularly preferably from 50 to 97% by weight of units of the formula (I);
   from 0.1 to 45% by weight, preferably from 1 to 40% by weight and particularly preferably from 2 to 35% by weight of units of the formula (III);
   from 0.1 to 30% by weight, preferably from 0.6 to 20% by weight and particularly preferably from 1 to 15% by weight of units of the formula (VI), where m=0.
   Copolymers of this type are obtainable in a known manner via free-radical-initiated copolymerization of acrylic acid, methacrylic acid, and/or esters thereof, or acrylonitrile or methacrylonitrile and unsaturated carboxylic anhydrides.
E. ABS polymer which contains from 0.1 to 30% by weight, preferably from 0.6 to 20% by weight, and particularly preferably from 1 to 15% by weight, of units of the formula (VI), where m=0. These can have been polymerized into the chains or can have been grafted onto the chains.
F. from 0 to 99.9% by weight, preferably from 0.1 to 99.4% by weight, and particularly preferably from 2 to 99% by weight, of units selected from the formulae (I), where R² is not H, and (III),
   from 0 to 60% by weight, preferably from 0.1 to 50% by weight, and particularly preferably from 2 to 40% by weight, of units of the formula (IV),
   from 0.1 to 30% by weight, preferably from 0.6 to 20% by weight, and particularly preferably from 1 to 15% by weight, of units of the formula (VII).
G. from 0 to 99.9% by weight, preferably from 0.1 to 50% by weight, and particularly preferably from 2 to 40% by weight, of units selected from the formulae (I), where R² is not H, and (III),
   from 0 to 60% by weight, preferably from 0.1 to 50% by weight, and particularly preferably from 2 to 40% by weight, of units of the formula (IV),
   from 0.1 to 30% by weight, preferably from 0.6 to 20% by weight, and particularly preferably from 1 to 15% by weight, of units of the formula (VIII).

The copolymer can always contain other additional monomer units, such as those which derive from maleic diesters, from fumaric diesters, from itaconic esters from vinyl acetate, as long as the desired adhesion-promoting effect is not substantially impaired thereby.

In one embodiment, the adhesion promoter can be composed entirely of the copolymer; in a variant of this, the copolymer comprises an impact modifier, e.g. an acrylate rubber.

In another embodiment, the adhesion promoter comprises from 2 to 99.9% by weight, preferably from 5 to 90% by weight, particularly preferably from 10 to 80% by weight, with particular preference from 15 to 60% by weight, and very particularly preferably from 20 to 40% by weight, of the copolymer, and from 0.1 to 98% by weight, preferably from 10 to 95% by weight, particularly preferably from 20 to 90% by weight, with particular preference from 40 to 85% by weight, and very particularly preferably from 60 to 80% by weight, of any desired polyamide. The adhesion at the two interfaces is in this case mainly brought about via the copolymer. It is, of course, also possible to promote the adhesion by selecting the polyamide from the semicrystalline polyamide of the film, the amorphous polyamide of the substrate, a polyamide which is similar to the polyamide of the film and/or to the polyamide of the substrate, and mixtures thereof.

The adhesion promoter can comprise the usual auxiliaries and additives, e.g. flame retardants, stabilizers, plasticizers, processing aids, dyes, pigments or the like. The amount fed of the agents mentioned is to be such as not to give any serious impairment of the desired properties.

The film can, as a function of the application, comprise further layers alongside the layer present according to the invention composed of a polyamide moulding composition and, if appropriate, alongside an adhesion-promoter layer, examples being a supportive layer on the substrate side composed of a polyamide moulding composition whose polymer constitution is preferably substantially the same as that of the substrate, a colour layer, a further polyamide layer, for example in the form of backing layer, and/or a protective layer or a clear coat.

The colour layer can be a lacquer layer; however, it is preferably composed, in accordance with the prior art, of a coloured thermoplastic layer. The thermoplastic layer can be identical with the layer according to I. a). In a further embodiment, the colour layer can follow the layer according to I. a), towards the outside or towards the inside. If appropriate, and if required for reasons of applications technology, the film is covered by a clear coat towards the outside, in order, for example, to ensure that the colouring has a desired depth effect. Examples of colorants that can be used are organic pigment dyes, inorganic or organic pigments, or metal flakes.

The clear coat can, for example, in accordance with the prior art, be composed of polyamide, of an acrylate polymer, of a fluoropolymer, or of a mixture thereof. It is intended to provide the visual surface properties demanded and to protect the layers lying thereunder. It can also, for example, be a clear lacquer based on polyurethane. A protective layer in the form of a lacquer can also have been modified in accordance with the prior art in order to increase scratch resistance. A protective layer can also be generated on the component by way of vacuum-deposition processes.

If the clear coat is a polyamide, materials that can be used for this purpose are in particular the polyamides mentioned above as particularly suitable for the film.

The clear coat can, if appropriate, have transparent colouring, but is preferably uncoloured.

A supportive layer is a layer whose thickness gives greater strength to the film.

A peelable protective film which provides protection during transport or assembly and which is peeled off after production of the composite part can also be laminated to the finished multilayer film.

In one preferred embodiment, the layer according to I. a), the colour layer and/or the supportive layer comprises a moulding composition which comprises a polyetheramide or a polyetheresteramide, and preferably a polyetheramide or polyetheresteramide based on a linear aliphatic diamine having from 6 to 18 and preferably from 6 to 12 carbon atoms, on a linear aliphatic or aromatic dicarboxylic acid having from 6 to 18 and preferably from 6 to 12 carbon atoms and on a polyether having an average of more than 2.3 carbon atoms per oxygen atom and having a number-average molecular weight of from 200 to 2000. The moulding composition of this layer can comprise other blend components, e.g. polyacrylates or polyglutarimides having carboxy or carboxylic anhydride or epoxy groups, a rubber containing functional groups, and/or a polyamide. Moulding compositions of this type are prior art; they are described by way of example in EP 1 329 481 A2 and DE-A 103 33 005, expressly incorporated herein by way of reference. In order to provide good layer adhesion with respect to any following polyamide layer present towards the outside or else towards the inside, it is advantageous that the polyamide fraction of the polyamide elastomer here is composed of monomers identical with those used in one of the components of the polyamide layer. However, this is not essential to achieve good adhesion. As an alternative to the polyamide elastomer, the layer according to I. a), the colour layer and/or the supportive layer can also comprise a usual impact-modifying rubber, alongside a polyamide. An advantage of these embodiments is that in many cases there is no need for thermoforming of the film as a separate step prior to reverse coating by an injection-moulding method, since that process also simultaneously subjects the film to a forming process.

Examples of useful layer arrangements of the film used according to the invention, in each case from the outside to the inside (towards the substrate) are:
a) layer according to I. a/adhesion-promoter layer
b) layer according to I. a/adhesion-promoter layer/layer composed of amorphous polyamide
c) clear coat/layer according to I. a) as colour layer/adhesion-promoter layer
d) clear coat/colour layer/layer according to I. a)/adhesion-promoter layer
e) clear coat/backing layer/layer according to I. a)/adhesion-promoter layer
f) clear coat/colour layer/backing layer/layer according to I. a)/adhesion-promoter layer
g) clear coat/colour layer/backing layer/layer according to I. a)/adhesion-promoter layer/layer composed of amorphous polyamide

In one preferred embodiment, the thickness of the film is from 0.02 to 1.2 mm, particularly preferably from 0.05 to 1 mm, very particularly preferably from 0.1 to 0.8 mm, and with particular preference from 0.2 to 0.6 mm. In one preferred embodiment here, the thickness of the adhesion-promoter layer is from 0.01 to 0.5 mm, particularly preferably from 0.02 to 0.4 mm, very particularly preferably from 0.04 to 0.3 mm, and with particular preference from 0.05 to 0.2 mm. The film is produced by means of known methods, for example via extrusion, or in the case of multilayered systems via coextrusion or lamination. It can then be subjected to a forming process, if appropriate.

The coherent bonding of the film to the substrate can be produced, for example, via adhesive bonding, pressing, lamination, or extrusion, or reverse coating by an injection-moulding, foaming or compression-moulding method. Prior to formation of the bond between film and substrate, the film can also be subjected to mechanical working or to a forming process, for example via thermoforming or other processes. The surface can, for example, be textured via embossing. Texturing of the surface is also a possible upstream step in the context of extrusion of a film, for example via specifically designed rolls. The resultant composite part can then be subjected to a forming process.

In one preferred embodiment, the claimed film is used as outer layer of an optical component. Examples of these are diffuser sheets, headlight lenses, tail-light lenses, other lenses, prisms, spectacle lenses, displays, decorative components for displays, panels of any type, and mobile-telephone casings.

In another preferred embodiment, the film according to the claims is used as outer layer of a film composite for the design or decoration of surfaces on and in automobiles and commercial vehicles, where the film has adhesive bonding to the substrate. The correspondingly designed component can have been shaped in the form of a sheet, for example a bodywork part, such as a roof module, wheel surround, engine cover or door. Other embodiments that can be used are those in which elongate components having some degree of curvature are produced, for example cladding, such as the cladding of what are known as A columns on an automobile, and decorative and cover strips of any type, for example radio covers. Protective cladding for door sills is another example. Alongside applications on the exterior of automobiles, constituents of the interior can also be advantageously decorated via the inventive films, in particular decorative elements such as strips and panels, since impact resistance and resistance to chemicals, such as cleaning compositions, is also a requirement in the interior.

The film can moreover be used, for example, as protective film with respect to soiling, UV radiation, effects of weathering, chemicals or abrasion, as barrier film on vehicles, in households, on floors, tunnels, or tents and on buildings, or as a carrier of decorative effects, for example for topcoats of sports equipment, of boats, of aircraft, or in the household, or on buildings. Other examples here are medical items, sanitary items and hygiene articles, e.g. shavers, electric toothbrushes, and medical equipment and, respectively, components.

The following examples are intended to illustrate the invention. The following materials were used in the examples:

PA PACM12: TROGAMID® CX7323 (Degussa GmbH)

PA12: A type whose relative solution viscosity ηᵣₑₗ is 2.1, determined to ISO 307

PA1012: A type whose relative solution viscosity ηᵣₑₗ is 2.1

PA1010: A type whose relative solution viscosity ηᵣₑₗ is 2.0

Adhesion promoter A copolymer whose constitution

(AP): is
a) 57% by weight of monomer units of the formula

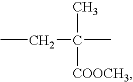

b) 30% by weight of monomer units of the formula

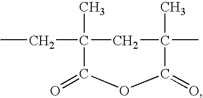

c) 3% by weight of monomer units of the formula

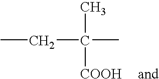

d) 10% by weight of monomer units of the formula

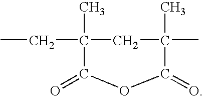

The copolymer, a polymethacrylimide, can be prepared via reaction of a melt of polymethyl methacrylate (PMMA) with an aqueous methylamine solution, for example in an extruder.

Amorphous polyamide:
TROGAMID® T5000, polyamide composed of terephthalic acid and 2,2,4-/2,4,4-trimethylhexamethylenediamine

The multilayer films were produced on a Collin plant whose take-off speed was 2.0 m/min. The individual extruded layers were combined and run through a calender. The width of the films was 24 cm; the thickness of the polyamide layer was about 180 μm and the thickness of the adhesion-promoter layer was about 240 μm.

The reverse coating by an injection-moulding method was carried out on an Engel 650/200 machine using a mould temperature of 90° C. and a melt temperature of 300° C. The film here was trimmed to 100 mm×150 mm format and placed in a mould (105 mm×150 mm x 0.8-10 mm sheet). The thickness of the sheet thus coated was 3 mm, inclusive of film.

For comparative measurements, sheets composed of amorphous polyamide, but without film, were produced correspondingly.

The following properties were measured on the film side of the composite sheets and on the comparative sheets composed of amorphous polyamide:
abrasion by the abrasive-wheel method (Taber) to DIN 53 745;
chemicals resistance (storage of sheets of corresponding specimens with full contact at 20° C. for 24 hours; the sheets were placed in a stand in a glass beaker and the surface was then assessed visually).

The results are given in Table 1.

TABLE 1
Inventive Examples 1 to 4 and Comparative
Example A; test results

| | Example | | | | |
|---|---|---|---|---|---|
| | 1 | 2 | 3 | 4 | A |
| Film | PA | PA12/AP | PA | PA 1010/ | — |
| | PACM12/ | | 1012/AP | AP | |
| | AP | | | | |
| Substrate | Amorphous | Amorphous | Amorphous | Amorphous | Amorphous |
| | polyamide | polyamide | polyamide | polyamide | polyamide |
| Gravimetric | 10 | 8 | 9 | 9 | 15 |
| abrasion | | | | | |
| [mg/100 revs.] | | | | | |
| Chemicals | | | | | |
| resistance: | | | | | |
| Methanol | +^{a)} | +^{a)} | 0^{b)} | 0^{b)} | −^{c)} |
| Ethanol | +^{a)} | +^{a)} | 0^{b)} | 0^{b)} | −^{c)} |
| Isopropanol | +^{a)} | +^{a)} | +^{a)} | +^{a)} | −^{d)} |

^{a)}no change
^{b)}softens, otherwise no adverse changes with regard to cracking or transparency
^{c)}severe softening; some separation
^{d)}severe surface attack

When an attempt was made to separate the composites mechanically, firm adhesion at the boundaries between the layers was found in Inventive Examples 1 to 4. In all cases the result was not separation, but instead was cohesive failure of the layers of the film.

1. A film which comprises a layer of comprising
a moulding composition that comprises at least one semicrystalline polyamide having an enthalpy of fusion of at least 8 J/g, measured to ISO 11357, wherein said layer is disposed on a substrate comprising a substantially amorphous polyamide having an enthalpy of fusion of less than 8 J/g.

2. The film according to claim 1, wherein an adhesion-promoter layer is disposed on the substrate.

3. The film according to claim 2, wherein
the adhesion promoter comprises of a polyamide which is identical with or similar to said semicrystalline polyamide, and of a polyamide which is identical with or similar to said substantially amorphous polyamide substrate.

4. The film according to claim 2, wherein
the adhesion promoter comprises from 2 to 100% by weight of a copolymer which comprises as monomer units:
from 70 to 99.9% by weight of monomer units which derive from vinyl compounds selected from the group consisting of acrylic acid derivatives, methacrylic acid derivatives, α-olefins and vinyl aromatics, and
from 0.1 to 30% by weight of monomer units which comprise a functional group selected from the group consisting of a carboxylic anhydride group, an epoxide group and an oxazoline group.

5. The film according to claim 4, wherein
the copolymer comprises as monomer units:
a) from 70 to 99.9% by weight of monomer units selected from units of formulae: 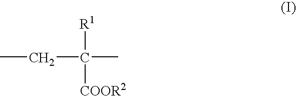
where R¹═H or CH₃ and R²═H, methyl, ethyl, propyl or butyl; 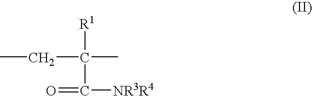
where R¹ is as above and R³ and R⁴, independently of one another, are H, methyl or ethyl; 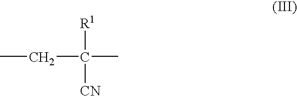
where R¹ is as above; 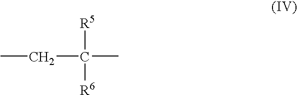
where R⁵═H or CH₃ and R⁶═H or C₆H₅; 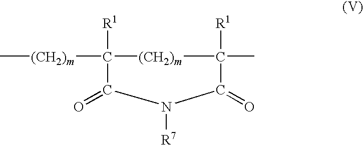
where R¹ is as above and R⁷═H, methyl, ethyl, propyl, butyl or phenyl and m=0 or 1;
b) from 0.1 to 30% by weight of monomer units selected from units of formulae: 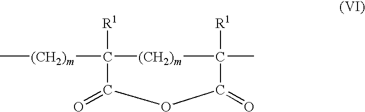
where R¹ and m are as above; 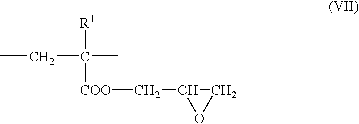
where R¹ is as above; 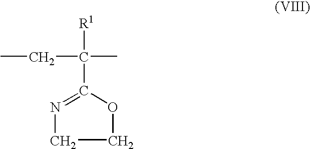
where R¹ is as above.

6. The film according to claim 4, wherein
the adhesion promoter comprises
from 2 to 99.9% by weight of the copolymer and
from 0.1 to 98% by weight of polyamide.

7. The film according to claim 1,
which comprises one or more further layers selected from the group consisting of
a backing layer comprising a polyamide moulding composition, on the substrate side,
a colour layer,
a further polyamide layer,
a protective layer or a clearcoat, and
a peelable protective film.

8. The film according to claim 1, comprised within a
composite part produced via adhesive bonding, pressing, or lamination, or via reverse coating by an injection-moulding, foaming or compression-moulding method.

9. A composite part of comprising
a film according to claim 1 and
a substrate comprising a moulding composition comprising a substantially amorphous polyamide having an enthalpy of fusion of less than 8 J/g, measured to ISO 11357.

10. A composite part according to claim 9, wherein
the substrate is in the form of a sheet.

11. The composite part according to claim 9,
in the form of
an optical component, a part of an automobile or utility vehicle, a medical item, a sanitary item, or a hygiene article.

12. A process for producing the composite part according to claim 9, comprising:
adhesive bonding, pressing, laminating, injection-moulding, foaming, or compression-moulding said film and said substrate to obtain said composite part.

13. The film according to claim 5, wherein
the adhesion promoter comprises
from 2 to 99.9% by weight of the copolymer and
from 0.1 to 98% by weight of polyamide.
